(19) United States
(12) Patent Application Publication
(10) Pub. No.: US 2010/0011671 A1
(43) Pub. Date: Jan. 21, 2010

(54) SEALING PROFILE AND SEALING SYSTEM INCLUDING THE SAME

(75) Inventor: Martin Gentemann, Harsum (DE)

Correspondence Address: FOX ROTHSCHILD LLP, 2000 MARKET STREET, 10th Floor, PHILADELPHIA, PA, 19103, US

(73) Assignee: METEOR GUMMIWERKE K.H. BADJE GMBH & CO. KG, Bockenem (DE)

(21) Appl. No.: 12/531,428

(22) PCT Filed: Jan. 25, 2008
(86) PCT No.: PCT/EP2008/000557

§ 371 Date: Sep. 15, 2009

(30) Foreign Application Priority Data
Mar. 15, 2007 (DE) 20 2007 003 837.2

(51) Int. Cl. B60J 10/04; E06B 7/16

(52) U.S. Cl. 49/489.1; 49/475.1; 49/490.1

(57) ABSTRACT

The invention relates to a sealing profile (27) which is used as a seal on the window (4) of a vehicle door and which consists of a fastening section (28) to be put onto a ridge (13) and a sealing section (30) designed to rest against the window (4) when the latter is closed. The sealing section (30) is characterized by at least one sealing lip (32) onto the free end of which a section (32′) is molded which is bent in the direction of the fastening section (28). Said bent section is deflected in the direction of the lower side (31′) of an additional sealing lip (31) when the window (4) is closed and defines therewith a closed space (33) that is open in the open state of the window (4). The space (33) formed by the sealing lip (31) being rolled up results in favorable damping properties and reduced closing forces as compared to a classical hollow profile, owing to an increased supporting effect on ventilation.

The invention relates to a sealing profile in accordance with the preamble of claim 1. The invention further relates to sealing systems that include such sealing profiles in accordance with the preambles of claims 7, 8 and 9.

Sealing assemblies of this kind are used for sealing the door channel in a vehicle door, within which a pane of glass can be lowered into its open position. When the glass is in this position, it must be possible to reliably prevent any foreign bodies, for example dirt particles or precipitation, from getting into the channel. The same is true for the closed position, in which the sealing assembly cooperates directly with the surfaces of the glass facing it to form a seal. A further requirement of such a sealing assembly relates to the guidance and holding properties the sealing assembly must exert on the pane. These properties relate to the vibration behaviour of the glass-sealing assembly system, for example reverberation times. The glass is known to be subject to vibrating loads when the vehicle is driven and when the doors are closed, and the glass support system must absorb these without starting to vibrate itself.

A sealing assembly is known from DE 41 19 704 that is characterized by two identical sealing profiles extending along both sides of the edge of the door channel. Each of these sealing profiles consists of a hollow profile, the interior of which may be charged with overpressure or underpressure, so that the contact force of the sealing profiles on the glass can be controlled depending on the position and state of motion of the glass, and so that the door channel can be closed off in sealing manner when the glass is in the fully open position.

From U.S. Pat. No. 5,388,371, a sealing assembly is known that consists of two sealing profiles, which are identical to each other and are to applied both externally and internally with respect to the border of a door channel, and which are configured to cooperate in sealing manner with a pane of glass. Each sealing profile consists of one fastening and one sealing section that is characterized by two sealing lips which are separated from each other and extend upwards at an angle to the glass, and of which one is constructed as a hollow profile. Both sealing lips are furnished with a flock coating on the side thereof facing the glass.

A further comparable sealing profile is known from JP 2002 254 9333, and consists of a U-shaped fixing section designed for fastening to an edge section of a vehicle body, and a sealing section. The sealing section is characterized by two sealing lips, the lower of which is constructed as a hollow profile. The sealing lips, in particular the sections thereof that come into contact with the glass, are made from a different plastic than the other sections.

All of the sealing assemblies described in the preceding have been designed with a view to ensuring their sealing function, and in the case of DE 41 19 704, ensuring that the glass pane can be operated without difficulty. On the other hand, guidance and cushioning functions, which are also essential properties of a sealing assembly, have not been addressed in these sources. Such functions are extremely important, particularly but not solely in the case of frameless windows.

Another sealing assembly for the window channel of a vehicle door and among other properties also designed for cooperation with a window from the outside is known from DE 10 2005 049 146, the sealing section of which consists of a peeling lip and a sealing lip, which are conformed on a lever-like element that swivels on a fastening section in the manner of a hinge due to a thinner section of material. The movement of the glass into or out of the window channel is intended to cause the two lips to move in the same way, and thereby represent good sealing and also a good guiding effect. The sealing lip is convex towards the glass and when the glass is in the closed position it encloses a practically closed space together with an opposing area of the fastening section.

In this context, the object of the invention is to suggest a sealing profile of the kind described in the introduction that offers improved guidance and damping properties with flexible use and reliable sealing effect. This object is solved in such a sealing assembly by the features of the characterizing part of claim 1.

Accordingly, an essential feature of the invention is that sealing lips of the sealing profile are created in such manner that when used in the intended manner as a result of pressing against the window, for example when the window is moved upwards within the door channel from an open position to a closed position, they undergo an elastic deflection such that in this deflected condition they create a closed profile enclosing a defined space. This space may have various geometric shapes—however, this profile is characterized at all times in that the sealing lip forms a rolled structure, thereby enclosing a hollow space. The difference between this and a sealing lip conformed as a hollow profile known from the prior art as represented in the introduction consists in significantly improved damping properties, which also result in the exertion of stable guidance function, which in turn enables suppression of the vibrations caused for example by driving, but also by door closing actions, and in particular short reverberation times. Moreover, less force is required to close the door than with a closed hollow profile, even if such is furnished with deaeration holes, because air may be expelled more effectively through the sealing lips according to the invention. In this condition, the two sealing lips cooperating within the limits of the hollow space described may be for example partially rolled up together or otherwise interlaced with each other. Since a section is conformed on the free end of the one sealing lip, and this section is brought to rest against the adjacent other sealing lip and angled towards said sealing when the window is in the closed state, it is easier for the free end of the one sealing lip to slide along the facing surface of the other sealing lip while forming the closed profile. In this way, the one sealing lip is subject to improved guidance in the direction of circumferential closure of the profile. It is also noteworthy that the damping effect due to friction that results from this contact may be modified in many ways through the design thereof, with respect to the dimensioning of the contact surfaces between the two sealing lips, the contact forces exerted, the constitution of the contacting surfaces, and the material pairs used.

The features of claim 2 are known as such from other sealing profiles. They enable the sealing profiles to be installed and removed particularly easily.

The features of claim 3 include the advantage that any liquid or dirt particles sticking to the window may be removed particularly reliably, for example when the window is moved to the open position starting from the closed position.

The coatings provided in accordance with claims 4 and 5 may serve various purposes. For example, they may be protective coatings or also decorative coatings. Coatings that reduce friction and wear as well as coatings that improve the performance of a cleaning function on the glass are also conceivable.

The features of claim 6 are directed to further configurations of the sealing sections. Equipping such sections with additional sealing lips results in further improvement of the guidance functions on the glass that are produced by the sealing assemblies, which further improve the positional stability of the window.

A further object of the invention is a construct a species-related sealing assembly for the purpose of improving the damping and guidance properties for the glass. This object is solved in an alternative manner by the features of the characterizing parts of claims 7 to 9.

Accordingly, various spatial arrangements of the sealing profiles according to the invention are possible within the scope of a sealing assembly assigned to a door border. In a first variation, sealing profiles of such kind may be attached to the outside of the sealing assembly or of a car body. In a second variation, these sealing profiles may be provided on the inside thereof. Finally, the possibility also exists to provide such sealing profiles on both the inside and the outside, thereby creating a symmetrical configuration of the sealing assembly. In summary, sealing profiles of such kind may be applied in multiple configurations to the outside and/or the inside.

Other sealing profiles of a sealing assembly may also have three or more sealing lips, in accordance with the features of claim 10, enabling them to exert a stable guidance function on the window.

The fastening sections of the sealing profiles may be used for attaching additional profile elements in accordance with the features of claim 11. In this context, decorative strips, decorative bars or similarly ornamental objects may be cited for exemplary purposes only.

According to the features of claim 12, the sealing profiles may be made from elastomer materials, particularly thermoplastic elastomers. These may be manufactured particularly expediently in an extrusion process, for example from foam rubber, EPDM (ethylene-propylene diene elastomer), SBR (styrene-butadiene elastomer), CR (chloroprene elastomer), blended from EPDM, SBR, polyoctenamer and NBR (acryl nitrile butadiene elastomer), from thermoplastic elastomers and TPO-based alloys.

The features of claims 13 and 14 are directed to a further configuration of the fastening sections. These may be provided with reinforcing elements, with which it is possible to realise permanent elastic biasing in the clasped position. This results in a reliable fastening condition. The sealing assembly according to the invention represents a component that may be varied in many different ways and is also suitable for compensating for component tolerances in the area of vehicle bodywork.

In the following, the invention will be explained in greater detail with reference to the embodiment represented diagrammatically in the drawing of a sealing assembly including a sealing profile according to the invention. In the drawing:

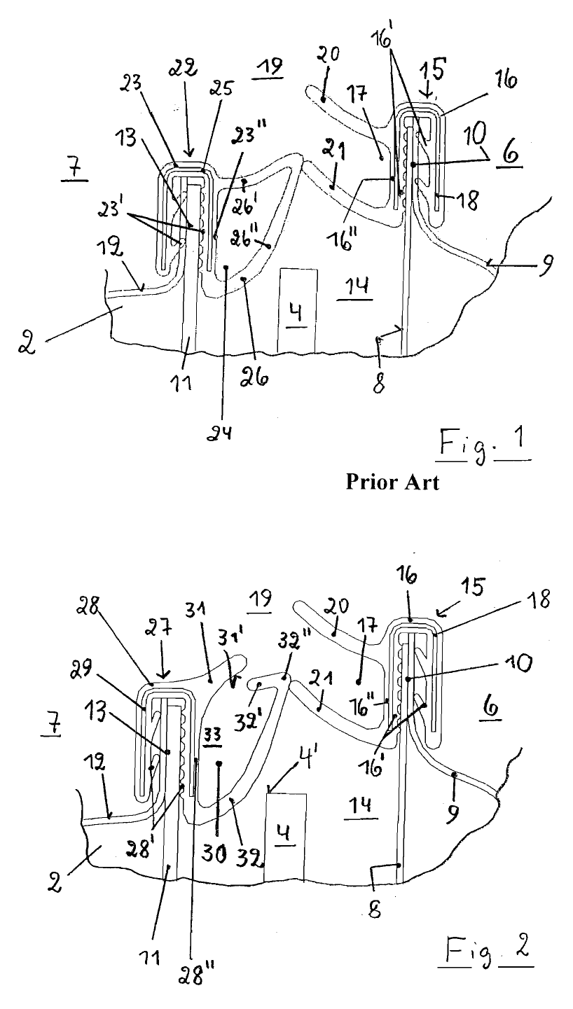

FIG. 1 shows a cross-section of a sealing assembly representative of the prior art and with the window of a vehicle door in the open position;

FIG. 2 shows a cross-section of an embodiment of a sealing assembly according to the invention and with the window of a vehicle door in the open position;

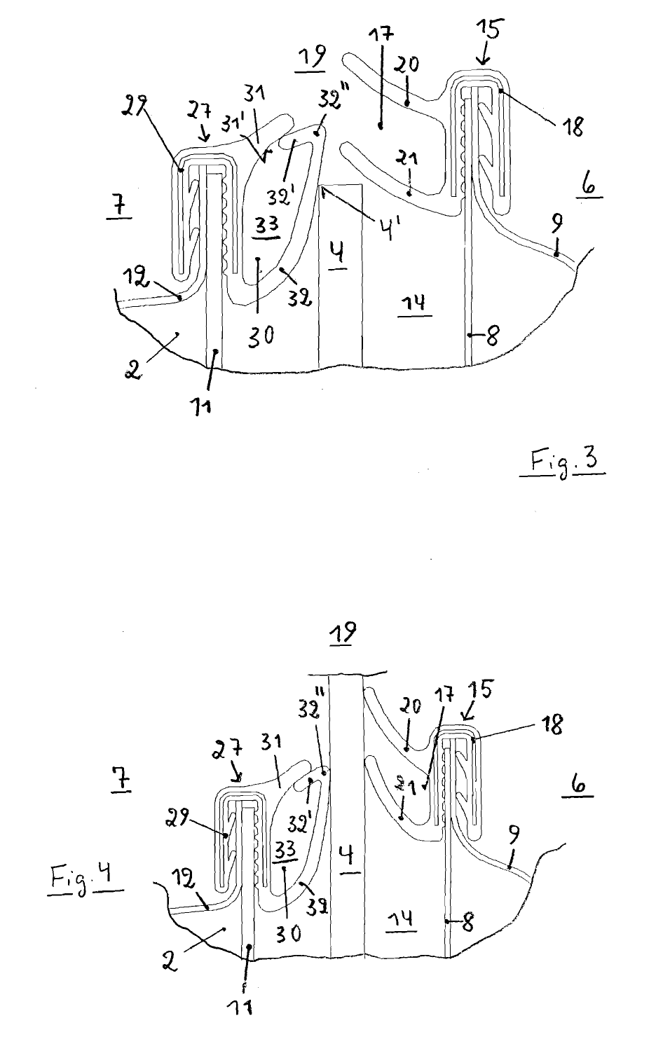

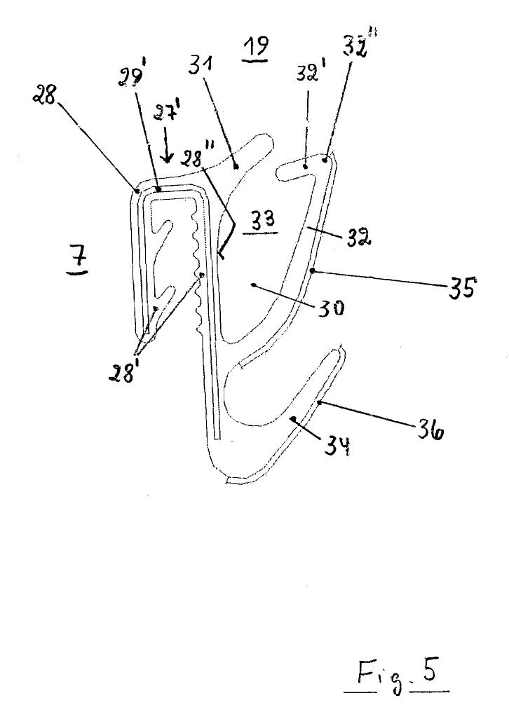

FIGS. 3, 4 each show sequential positions of the window during a closing movement of the window starting from the position of the window shown in FIG. 2;

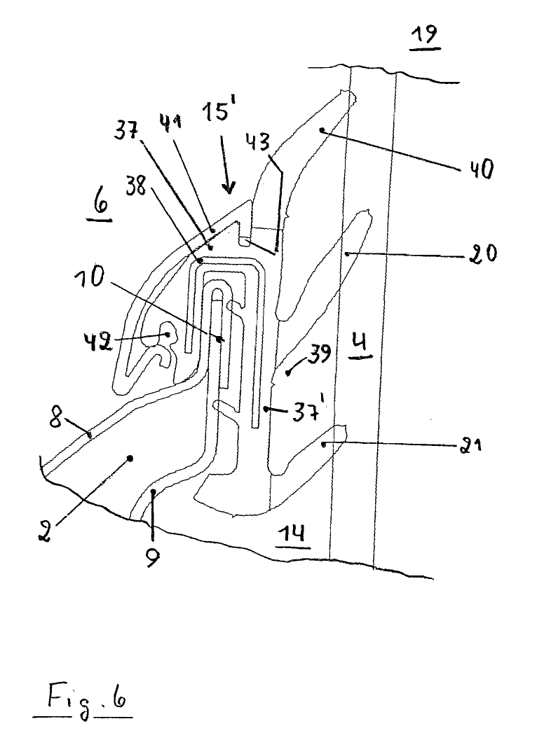

FIG. 5 shows a modified example of an interior sealing profile as a part of the sealing assembly according to the invention;

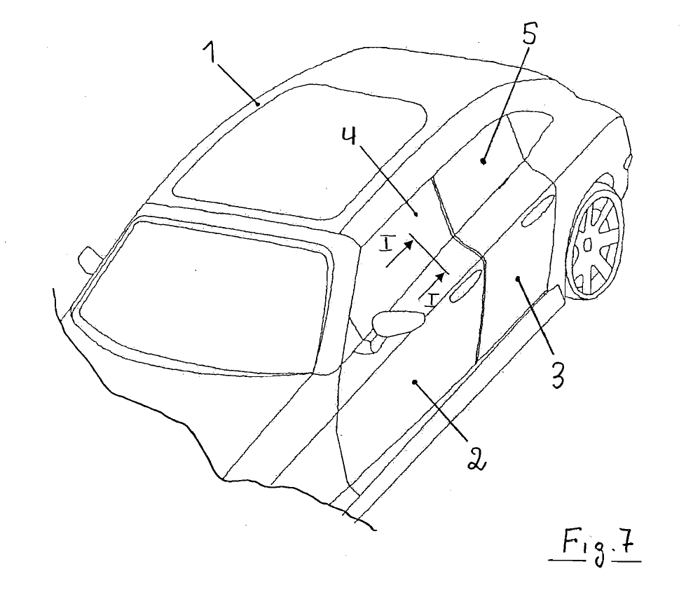

FIG. 6 shows a modified example of an exterior sealing profile as a part of the sealing assembly according to the invention;

FIG. 7 is a perspective view of part of a car body illustrating the installation sites of these sealing assemblies.

The following explanation will refer first of all to FIGS. 1 and 7 of the drawing, FIG. 7 showing a car body 1 having two side doors 2, 3, the windows 4, 5 of which are steplessly displaceable in the normal way between a closed position and an open position, in which the window is lowered into a door channel 14. It is unimportant whether the windows are frameless or whether they are of a type that is surrounded by a frame. It is also unimportant whether the windows are associated with electric window lifts or are only movable manually between the positions described.

As shown in FIG. 1, the side of the door structure facing the outside of the vehicle 6 is characterized by two panels 8, 9, the free ends of which converge to form a vertical ridge 10. The side of the door structure facing the inside of the vehicle 7 is also characterized by two panels 11, 12, the free ends of which converge to form a vertical ridge 13. Ridges 10, 13 are positioned apart from one another and extend vertically and parallel to panels 8, 10, which are located on the respective inner sides of the door structure, and thereby form the lateral limits of door channel 14, within which window 4 may be lowered, representing the opened position of the door window. In order to keep the drawing as uncomplicated as possible, the function elements that serve to guide the window are not shown. These are known as such to one skilled in the art and do not need further explanation.

Numeral 15 designates an outside sealing profile consisting of a U-shaped fastening section 16 and a sealing section 17 conformed thereon. Fastening section 16, furnished for example with a metallic reinforcing element 18, is attached to ridge 10 and is retained thereon by friction with the aid of retaining profile elements 16′ that are conformed on the inner side of said section and by the elastic pressing forces exerted by reinforcing element 18.

Sealing section 17 consists of two sealing lips 20, 21 on leg 16″, which is conformed on the side of fastening section 16 facing door channel 14, and are set at a distance from one another and curved upwardly towards a top side 19, and are designed to create a sealing contact with window 4.

Numeral 22 designates an inside sealing profile consisting of a U-shaped fastening section 23 and a sealing section 24 conformed thereon. Fastening section 23, furnished for example with a metallic reinforcing element 25, is attached to ridge 13 and is retained thereon by friction with the aid of retaining profile elements 23′ that are conformed on the inner side of said section and by the elastic pressing forces exerted by reinforcing element 25.

Sealing section 24 consists of a hollow profile 26 on leg 23″, which is conformed on the side of fastening section 23 facing door channel 14, which is formed by two wall sections 26′, 26″ that curve upwards and outwards from said leg towards a top side 19 and have converging free ends.

Both sealing sections 17, 24 are situated such that when window 4 is in the fully open position as shown in FIG. 1, sealing lip 21 and hollow profile 26 are in elastically biased contact with one another, thereby forming a closure of door channel 14 that is sealed in the direction of top side 19.

When window 4 is moved to its closed position, the two sealing sections 17, 24 are elastically deflected towards the respective fastening sections 17, 23 and are thus brought into sealing contact on the respective sides of window 4.

The sealing behaviour of this known sealing assembly may be regarded as essentially satisfactory. To illustrate a damping assembly according to the invention, featuring significantly improved damping and guidance behaviour with respect to the example above, reference is made in the following to FIGS. 2 to 4, which show sequential positions of window 4. Functional elements corresponding to those in FIG. 1 are designated with the same numerals, so that it is not necessary to repeat the description in this respect.

Sealing profile 15 which faces outside 6 corresponds to the profile of FIG. 1. Unlike in FIG. 1, a sealing profile 27 is placed over the U-shaped fastening section 28 on ridge 13, the fastening section preferably being furnished with metallic reinforcing element 29. Again, retaining profile elements 28′ are provided on the inside and cooperate with ridge 13 to secure the fastening position of fastening section 28.

A sealing section 30, consisting of a sealing lip 31 facing top side 19 and curved slightly upwards in that direction, and of a sealing lip 31 set apart from the first lip and curved similarly, is conformed on leg 28″ of fastening section 28 that faces towards door channel 14. The free end of sealing lip 32 is characterized by section 32′, which is angled or possibly curved inwards, that is to say towards fastening section 28 and upper sealing lip 31, wherein when window 4 is in the fully open position shown in FIG. 2 the free end of sealing lip 21 rests on the facing side of sealing lip 32, slightly below an area 32″ on which angled section 32′ is conformed. In this position, section 32′ and sealing lip 21 form an obtuse angle with one another, while section 32′ and the other part of sealing lip 32 form an acute angle with one another. Again, the flush position of sealing lip 21 against sealing lip 32 is characterized by elastic biasing created by the design.

It is apparent that when window 4 is in the open position shown in FIG. 2, there is no contact at all between the window and sealing lips 21, 32, and that a space 33 delimited by leg 28″, sealing lips 31, 32, and section 32′ is unoccupied when window 4 is in this position, since there is no contact between the free end of section 32′ and sealing lip 31.

Now, if window 4 starting from the position shown in FIG. 2 is moved towards the closed position, that is to say towards top side 19, window 4 first comes to rest against sealing lip 32, as shown in FIG. 3, and the sealing lip is deflected elastically towards sealing lip 31. Space 33 is now closed as soon as this deflection causes the free end of section 32′ to rest on the facing side of sealing lip 31, in this case, the underside 31′ thereof.

The continued upward travel of window 4 is characterized by a sliding action of the glass, particularly edge 4′ thereof, along sealing lip 32, which is deflected progressively towards underside 31′ until the condition shown in FIG. 4 is reached. In this position, sealing lip 32 has reached its maximum deflection and area 32″ now lies flush against window 4.

It is evident that in the positions shown in FIGS. 3 and 4, sealing lip 32 undergoes a rolling up process caused by its shape and its position relative not only to window 4, but also to sealing lip 31, with the result that space 33 now forms a circumferentially enclosed profile.

Closed space 33 instead of a hollow profile 26 as shown in FIG. 1 provides the advantage of significantly improved damping. This is largely due to the fact that almost any change in the cross-sectional profile of space 33 will cause relative movements in the contacting surfaces of section 32′ and of sealing lip 31, because these elements are frictionally bonded due to the material pairing used on the contact surfaces. The sealing section 30 that is defined by space 33 is thus characterized by elastic properties with sufficient restoring force and by improved damping properties, such that this sealing assembly is capable of exerting not only a reliable sealing but also stable guidance function on the glass, on which sealing sections 17, 30 are resting.

The drawing does not show the deaeration holes provided along at least one of sealing lips 31, 32, the size and distribution of which may be altered to further modify the damping behaviour of space 33 when window 4 is in the closed position.

FIG. 5 is a separate representation of a modified version 27′ of the sealing profile 27 shown in FIG. 2. The leg 28″ thereof which faces a door channel is prolonged in the same way as the reinforcing element 29′ that extends along the inside of the leg, and a further sealing lip 34 protrudes below and at a significant distance from sealing lip 32, the lower sealing lip being curved in a manner at least resembling the curvature of sealing lip 32. Besides a further improved sealing effect, this sealing profile is also responsible for further improvement in the guidance effect for window 4.

Numerals 35, 36 designate coatings whose function may differ according to the material used. For example, such coats may be designed to reduce friction and/or wear, or to improve damping still more. Other surface areas of sealing profile 27, 27′ may also be provided with coatings, particularly visible surfaces with a decorative coating.

FIG. 6 shows a variant 15′ of the sealing profile 15 of FIG. 2 in its installed position. This is attached to ridge 10 of a door 2 via a U-shaped fastening section 37. Leg 37′ of this fastening section faces door channel 14 and is elongated so that the reinforcing element 38 running along inside it is also elongated.

Sealing section 39 conformed on leg 37′ is characterized with respect to sealing section 17 of FIG. 2 in that it possesses a third sealing lip 40, which also extends towards window 4 and is designed to rest against the window in sealing manner. Thus it also lies flush with the window under elastic biasing. In this way, further improved sealing and guidance effect from the outside may be achieved.

If necessary, sealing lips 20, 21, 40 may be produced from material that is different, for example softer, than the basic material of fastening section 37.

Sealing profiles 15′ may be used in any combination with sealing profiles 27, 27′ of the type described in the preceding, to create a complete sealing assembly for a door channel. In all of the hollow spaces created by the sealing lips, particularly of outer sealing profiles 15, 15′, when window 4 is in the closed position, lateral line sections not shown in the drawing may be provided for transporting any water that penetrates to an assigned disposal system.

Numeral 41 designates a decorative rod or decorative strip made from metal or plastic, the sides of which are furnished with hook-like deformations, which are designed to engage with groove-like undercuts in the recesses 42, 43 in fastening section 37.

It is apparent that the sealing assembly according to the invention represents a component having improved properties over those of the prior art as described in the introduction, and it is easily installed, and in the event that it is damaged it may also be removed easily and replaced with another.

1. A sealing profile (27, 27′) for the window (4) of a vehicle door, arranged in a door channel (14) so as to be movable between a closed position and an open position, having a fastening section (28) and a sealing section (30) conformed thereon, wherein at least two sealing lips (31, 32) of the sealing section are provided at a distance from one another on the sealing section (30), and disposed on the fastening section (28) such that when the window (4) is in the open position a profile representing a space (33) delimited circumferentially by a leg (28″) of the fastening section (28) and the two sealing lips (31, 32) is open, and is closed due to deflection of a sealing lip (32) when the window (4) is in the closed position,
characterized in that
surface sections are provided and arranged on the opposing sides of sealing lips (31, 32), via which they engage frictionally—circumferentially closing the space (33)—when the window (4) is in the closed position, and that a section (32′) is conformed on the free end of at least one sealing lip (32), and is aligned to rest on the facing side (31′) of the adjacent sealing lip (31) when the window (4) is in the closed position, and which in order to support the movement of the sealing lip (32) opposite this sealing lip towards sealing lip (31) so as to produce the closed condition of the profile surrounding the space (33), is angled in such manner that frictionally charged relative movements of contacting surfaces of the section (32′) and the sealing lip (32) that cause sealing lip (32) to roll up lead to changes in the cross section of the space (33).

2. The sealing profile in accordance with claim 1, characterized in that the fastening section (28) forms an attachment profile with a U-shaped cross section.

3. The sealing profile in accordance with claim 1, characterized in that in the installed condition at least a part of the sealing lips (31, 32, 34) has a convex shape curving up towards a top side (19) of the door channel (14) of the vehicle door (2) and extending into the door channel (14).

4. The sealing profile in accordance with claim 2, characterized in that the surface sections of the sealing lips (32, 34) that come to rest on the facing surface of the window (4) are coated with a coating (35, 36).

5. The sealing profile in accordance claim 4, characterized in that the coating (35, 36) consists of a sliding lacquer, a flocking, or TPE (thermoplastic elastomer).

6. The sealing profile in accordance with claim 2, characterized in that the sealing section (30) of at least one sealing profile (27′) consists of two sealing lips (31, 32) for forming a closed profile surrounding the space (33) and at least one further sealing lip (34) at a distance therefrom.

7. The sealing assembly for edging the door channel (14) of a vehicle door (2) using sealing profiles (27, 27′) in accordance with claim 1,
characterized in that at least one sealing profile (27, 27′) whose sealing section (30) forms a closed profile surrounding a space (33) when the window (4) is in the closed position, is provided on the inside (7) of said edging.

8. The sealing assembly for edging the door channel (14) of a vehicle door (2) using sealing profiles (27, 27′) in accordance with claim 1,
characterized in that at least one sealing profile (27, 27′) whose sealing section (30) forms a closed profile surrounding a space (33) when the window (4) is in the closed position, is provided on the outside (6) of said edging.

9. The sealing assembly for edging the door channel (14) of a vehicle door (2) using sealing profiles in accordance with claim 1, characterized in that
at least one sealing profile (27, 27′) whose sealing section (30) forms a closed profile surrounding a space (33) when the window (4) is in the closed position, is provided on both the outside (6) and the inside (7) of said edging.

10. The sealing assembly in accordance with claim 7,
characterized in that the sealing section (39) of at least one sealing profile (15′) consists of at least three sealing lips (20, 21, 40) arranged at a distance from each other.

11. The sealing assembly in accordance with claim 7,
characterized in that the sealing section (37) of at least one sealing profile (15′) is constructed to allow the attachment of a further profile element, for example a decorative strip (41) or similar.

12. The sealing assembly in accordance with claim 7, characterized in that the sealing profile (15, 15′, 27, 27′) consists of elastomer materials, particularly thermoplastic elastomers.

13. The sealing assembly in accordance with claim 7, characterized in that
the fastening section (16, 37, 28) is furnished with a reinforcing element (18, 29, 29′, 38).

14. The sealing assembly in accordance claim 13,
characterized in that the reinforcing element is made from steel, aluminium, or even a plastic.

15. The sealing profile in accordance with claim 2, characterized in that in the installed condition at least a part of the sealing lips (31, 32, 34) has a convex shape curving up towards a top side (19) of the door channel (14) of the vehicle door (2) and extending into the door channel (14).

16. The sealing profile in accordance with claim 2, characterized in that the surface sections of the sealing lips (32, 34) that come to rest on the facing surface of the window (4) are coated with a coating (35, 36).

17. The sealing profile in accordance with claim 2, characterized in that the surface sections of the sealing lips (32, 34) that come to rest on the facing surface of the window (4) are coated with a coating (35, 36).

18. The sealing profile in accordance claim 3, characterized in that the sealing section (30) of at least one sealing profile (27′) consists of two sealing lips (31, 32) for forming a closed profile surrounding the space (33) and at least one further sealing lip (34) at a distance therefrom.

19. The sealing profile in accordance claim 4, characterized in that the sealing section (30) of at least one sealing profile (27′) consists of two sealing lips (31, 32) for forming a closed profile surrounding the space (33) and at least one further sealing lip (34) at a distance therefrom.

20. The sealing profile in accordance claim 5, characterized in that the sealing section (30) of at least one sealing profile (27′) consists of two sealing lips (31, 32) for forming a closed profile surrounding the space (33) and at least one further sealing lip (34) at a distance therefrom.
